(19) United States
(12) Patent Application Publication
(10) Pub. No.: US 2010/0166189 A1
(43) Pub. Date: Jul. 1, 2010

(54) Key Management Apparatus and Key Management Method

(76) Inventors: Toshihiro Morohoshi, Kawasaki-shi (JP); Masayuki Nishimoto, Ome-shi (JP); Satoshi Matsuda, Gyoda-shi (JP); Hidehito Izawa, Hanno-shi (JP); Kenji Koyano, Higashiyamato-shi (JP); Kazuhiro Takashima, Tokyo (JP); Shinzo Matsubara, Akishima-shi (JP); Hajime Oosawa, Kokubunji-shi (JP); Atsushi Nakamura, Hino-shi (JP); Masao Iwasaki, Ome-shi (JP); Yasuhiro Takahashi, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/643,710

(22) Filed: Dec. 21, 2009

(30) Foreign Application Priority Data
Dec. 26, 2008 (JP) 2008-334642
May 29, 2009 (JP) 2009-131285

(51) Int. Cl. H04L 9/08; G06F 12/14

(52) U.S. Cl. 380/284; 713/193

(57) ABSTRACT

According to one embodiment, a key management apparatus comprises a decrypting module configured to read a first media unique key and an encrypted content key corresponding to a selected content from a first information storage medium and to decrypt the encrypted content key with the first media unique key in order to obtain a content key in a plain version, an encryption module configured to read a second media unique key from a second information storage medium and to encrypt the content key in the plain version with the second media unique key in order to obtain an encrypted content key for the second medium, and a write module configured to write the encrypted content key for the second medium to a user data area of the second medium.

### CROSS-REFERENCE TO RELATED APPLICATIONS

This application is based upon and claims the benefit of priority from Japanese Patent Applications No. 2008-334642, filed Dec. 26, 2008; and No. 2009-131285, filed May 29, 2009, the entire contents of both of which are incorporated herein by reference.

### BACKGROUND

1. Field

One embodiment of the invention relates to a key management apparatus and a key management method, which are capable of managing an encrypted content and a key of the encrypted content in separate media.

2. Description of the Related Art

A Secure Digital (SD) card (trademark) that stores an encrypted content in a user data area, and also stores an encrypted content key, which is obtained by encrypting a content key used for encrypting content with a card-specific user key stored in a protected area, in the user data area is known (e.g., paragraphs [0004]-[0009] of Jpn. Pat. Appln. KOKAI Publication No. 2006-14035).

A new digital rights management (DRM) system, which is capable of protecting digital contents such as music, videos, and books against illegal copying and securely distributing the digital contents by utilizing a copyright protection function of the SD card to combine a key stored in an SD card and a corresponding viewer soft, has been designed.

Features of the above system are creating a secure key which is obtained by encrypting a key (right) itself for using a content, and distributing the key and the content separately, by utilizing the copyright protection function of the SD card and identification numbers (ID) unique to respective SD cards.

With the above features, distribution of content to users through any manners such as delivery of CD/DVD, download from the internet, and a super-distribution system became possible. Convenience for both of distributors distributing contents and users purchase content is thereby developed. The super-distribution system is a system wherein ease of distribution and copying being the characteristic of digital content is taken advantage for freely distributing encrypted content, and users are charged on the basis of actual use.

According to the DRM system, read and development of content for browsing the content becomes possible only when encrypted content and an encrypted key are together. Therefore, if only the content itself is copied and there is no key for the content, it is not possible to use the copied content. It becomes possible to distribute the content itself between individuals, as a development of the super-distribution. Also, a key to be stored in an SD card is encrypted in such a manner that it is related to an identification number (ID) unique to every SD card. Even if information on a key is copied, the key will not function without the SD card being the copy source, and content therefore cannot be used.

Now, in this DRM system, distribution of digital content by writing encrypted content and an encrypted key to an SD card will be considered. A conventional SD card has high confidentiality of a key. However, it has a disadvantage that, while an encrypted content wherein separate delivery for distributing a key and content separately is supported can be copied or moved to another medium, a key cannot be copied or moved to another medium. Therefore, when a plurality of contents are moved from a respective plurality of SD cards to other media, it becomes laborious to look for SD cards respectively storing encrypted content keys for respective encrypted contents. Furthermore, in the worst case, an SD card storing a key for an encrypted content moved to another medium may not be possible to be specified and the moved encrypted content cannot be reproduced.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram for showing operation of content reproduction according to a first embodiment of the present invention.

FIG. 2 is an exemplary diagram for showing a configuration of a reproduction apparatus of the first embodiment of the present invention.

FIGS. 3A, 3B, 30, and 3D are exemplary diagrams each of which shows movement of content in the first embodiment of the present invention.

FIGS. 4A, 4B, and 4C are exemplary diagrams each of which shows process of a key management method according to the first embodiment of the present invention.

FIG. 5 is an exemplary diagram for showing content reproduction in the first embodiment of the present invention.

FIG. 6 is an exemplary diagram for showing a configuration of a reproduction apparatus of the second embodiment of the present invention.

FIG. 7 is an exemplary diagram for showing an example of a key movement process according to the second embodiment of the present invention.

FIG. 8 is an exemplary diagram for showing another example of the key movement process according to the second embodiment of the present invention.

FIG. 9 is an exemplary diagram for showing a configuration of a reproduction apparatus and an account server according to a third embodiment of the present invention.

FIGS. 10A and 10B are exemplary diagrams each of which shows a purchase history managed by the account server of the third embodiment of the present invention.

FIG. 11 is an exemplary diagram for showing an example of a key movement process according to the third embodiment of the present invention.

### DETAILED DESCRIPTION

Various embodiments according to the invention will be described hereinafter with reference to the accompanying drawings. In general, according to one embodiment of the invention, a key management apparatus configured to access an information storage medium comprising a user data area for storing encrypted content and encrypted content key, the encrypted content being encrypted with a content key in a plain version and the encrypted content key being encrypted on the basis of a media unique key unique to the medium, and a hidden area for storing the media unique key, the apparatus comprises a decrypting module configured to read a first media unique key and an encrypted content key which corresponds to a selected content from a first information storage medium and to decrypt the encrypted content key with the first media unique key in order to obtain a content key in a plain version; an encryption module configured to read a second media unique key from the second information storage medium and to encrypt the content key in the plain version with the second media unique key in order to obtain an encrypted content key for the second information storage medium; and a write module configured to write the encrypted content key for the second information storage medium to a user data area of the second information storage medium.

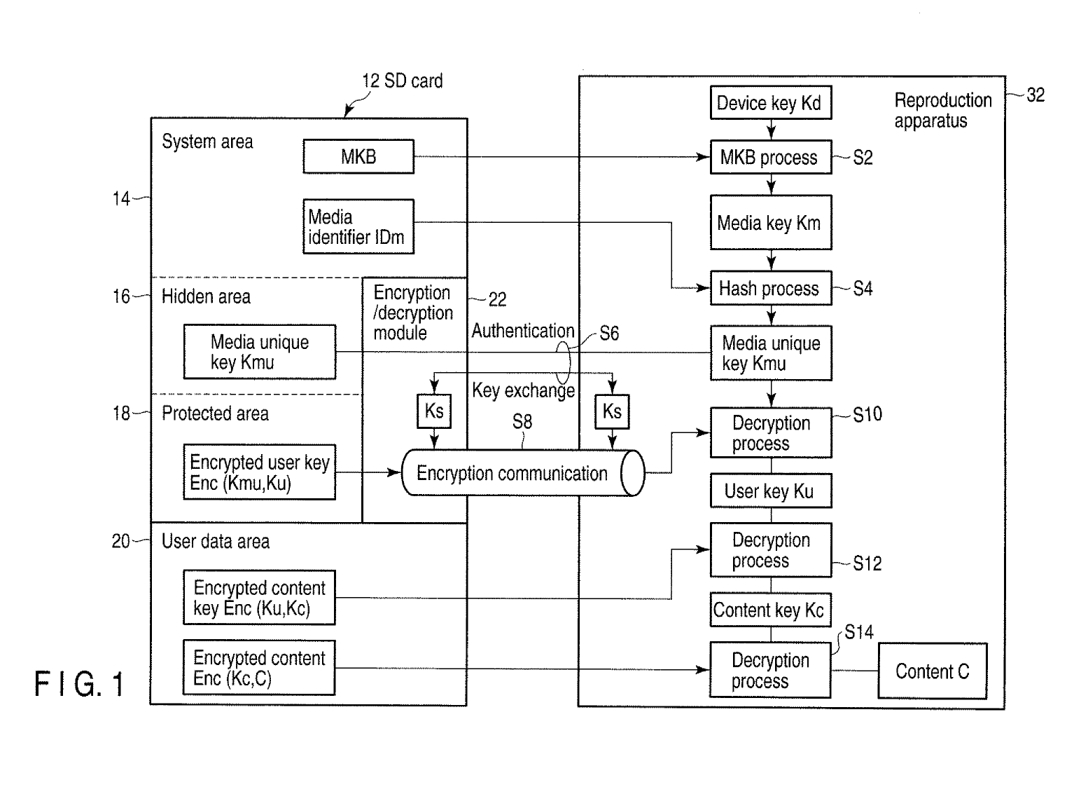

According to an embodiment, FIG. 1 is a diagram for showing an overall structure of a reproduction system of an SD card, which is an assumption of the present invention. The present reproduction system is a system for reproducing content stored in an information storage medium such as an SD card. Generally, an SD card, which stores an encrypted content being a reproduction target and a key for the encrypted content, is attached to a reproduction apparatus for reproduction. From a point of view for effectively using the SD card, a large-capacity storage device such as a hard disk is connected to or provided in the reproduction apparatus, and the encrypted content is moved to the large-capacity storage device to be stored therein.

A storage area of an SD card 12 is divided into a system area 14, a hidden area 16, a protected area 18, and a user data area 20. The SD card 12 also includes an encryption/decryption module 22.

The system area 14 stores key management information Media Key Block (MKB) and a media identifier IDm. The hidden area 16 stores a media unique key Kmu. The protected area 18 stores an encrypted user key Enc (Kmu, Ku). The user data area 20 stores an encrypted content key Enc (Ku, Kc) and an encrypted content Enc (Kc, C). Description of Enc (A, B) indicates, in the present specification, that data (also referred to as a key) B encrypted by data A. A user key Ku is an encryption/decryption key for a content key Kc, and, in the SD card 12, this user key Ku is commonly used for a plurality of encrypted content keys Enc (Ku, Kc1), and Enc (Ku, Kc2), . . . etc.

The system area 14 is a read only area to which a reproduction device 32 or the like can access from outside of the SD card. The hidden area 16 is a read only area to which the SD card itself refers, and this area can never be accessed from outside. The protected area 18 is an area which is readable/writable from outside of the SD card when authentication is successful. The user data area 20 is an area which is freely readable/writable from outside of the SD card. The encryption/decryption module 22 is for performing authentication, key exchange, and encryption communication between the protected area 18 and outside of the SD card, and it has an encryption/decryption function.

With respect to the above-explained SD card 12, the reproduction apparatus 32, which is a key management apparatus as well as a user terminal for reproduction, operates logically as explained below. That is to say, in the reproduction apparatus 32, key management information MKB read from the system area 14 the SD card 12 is subjected to an MKB process (S2) by a preliminarily-set device key Kd, and a media key Km is thereby obtained. The reproduction apparatus 32 then subjects the media key Km and a media identifier IDm read from the system area 14 of the SD card 12 to a hash process (S4) for obtaining a media unique key Kmu.

Subsequently, the reproduction apparatus 32 executes, on the basis of the media unique key Kmu, authentication and key exchange (Authentication Key Exchange [AKE]) process (S6) between the reproduction apparatus 32 and the encryption/decryption module 22 of the SD card 12, and shares a session key Ks with the SD card 12. The authentication and key exchange process of step S6 is successful when the media unique key Kmu in the hidden area 16 to which the encryption/decryption module 22 refers and the media unique key Kmu generated by the reproduction apparatus 32 match, and then the session key Ks is to be shared.

Next, the reproduction apparatus 32 reads the encrypted user key Enc (Kmu, Ku) from the protected area 18 through encrypted communication (S8) using the session key Ks, and subjects the encrypted user key Enc (Kmu, Ku) to a decryption process (S10) by using the media unique key Kmu, and thereby obtains the user key Ku.

Then, the reproduction apparatus 32 reads the encrypted content key Eric (Ku, Kc) from the user data area 20 of the SD card 12, and subjects the encrypted content key Enc (Ku, Kc) to a decryption process (S12) by using the user key Ku, and thereby obtains the content key Kc. The reproduction apparatus 32 reads the encrypted content Enc (Kc, C) from the user data area 20 of the SD card 12, and subjects the encrypted content key Enc (Kc, C) to a decryption process (S14) by using the content key Kc, and reproduces thereby obtained content C.

In the above basic example, the encrypted content Enc (Kc, C) is stored in the data area 20 of the SD cards 12. According to the present embodiment, however, a case where an encrypted content Enc is moved to another storage medium such as a hard disk will be explained. In other words, in decryption process (S14), encrypted content Enc (Kc, C) read from another storage medium is decrypted by using the content key Kc, which is obtained by decrypting the encrypted content key read from the SD card 12.

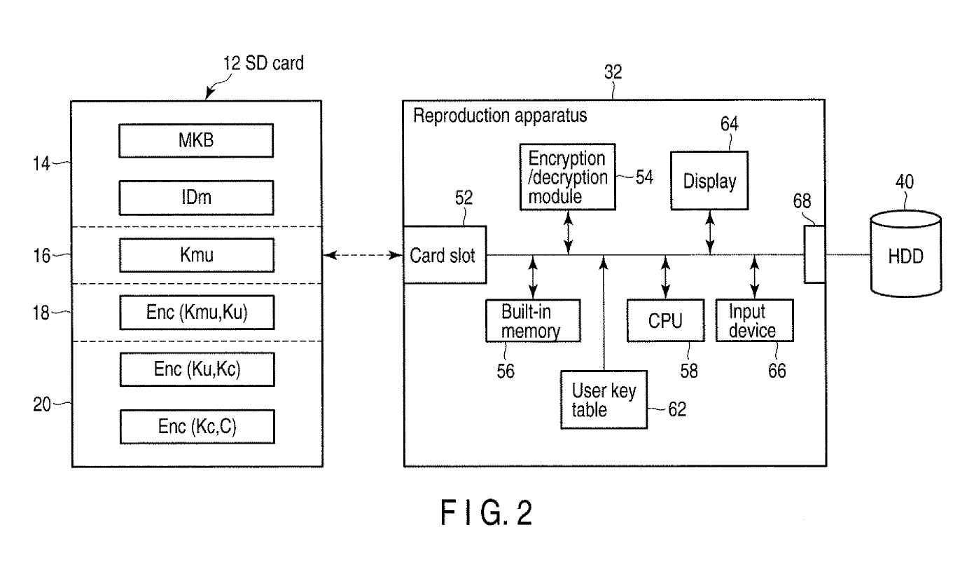

FIG. 2 is a diagram for showing a configuration of the reproduction apparatus 32 serving as a key management apparatus according to a first embodiment of the present invention. This system comprises the SD card 12, the reproduction apparatus 32, and a hard disk drive (HDD) 40. It is assumed that the SD card 12, at an initial state, stores an MKB, a media identifier IDm, a media unique key Kmu, and an encrypted user key Enc (Kmu, Ku). On the other hand, a content distribution terminal (not shown) encrypts content specified by a user with a content key Kc and writes an encrypted content Enc (Kc, C) to the user data area 20, when the SD card 12 is inserted. The content distribution terminal also encrypts the content key Kc with the user key Ku, and writes the encrypted content key Enc (Ku, Kc) to the user data area 20, thereby selling the content.

The SD card 12 is inserted into a card slot 52 of the reproduction apparatus 32. Inside the reproduction apparatus 32, an encryption/decryption module 54, a built-in memory 56, a CPU 58, a card slot 52, a user key table 62, a display 64, an input device 66, and a USB terminal 68 are connected to one another via a system bus. The encryption/decryption module 54 includes a process of decrypting encrypted content keys read from respective SD cards by using user keys of the respective SD cards and again encrypting the decrypted content key by using a user key of a specific SD card. Therefore, the reproduction apparatus 32 includes the user key table 62 which manages the user key of the specific SD card. The CPU 58 includes special software for key management. A user interface for guiding user's operation is displayed on the display 64, and user's operation is inputted via the input device 66. The input device 66 may employ a touch panel system wherein the display 64 is combined therewith. The HDD 40 is connected to the USB terminal 68.

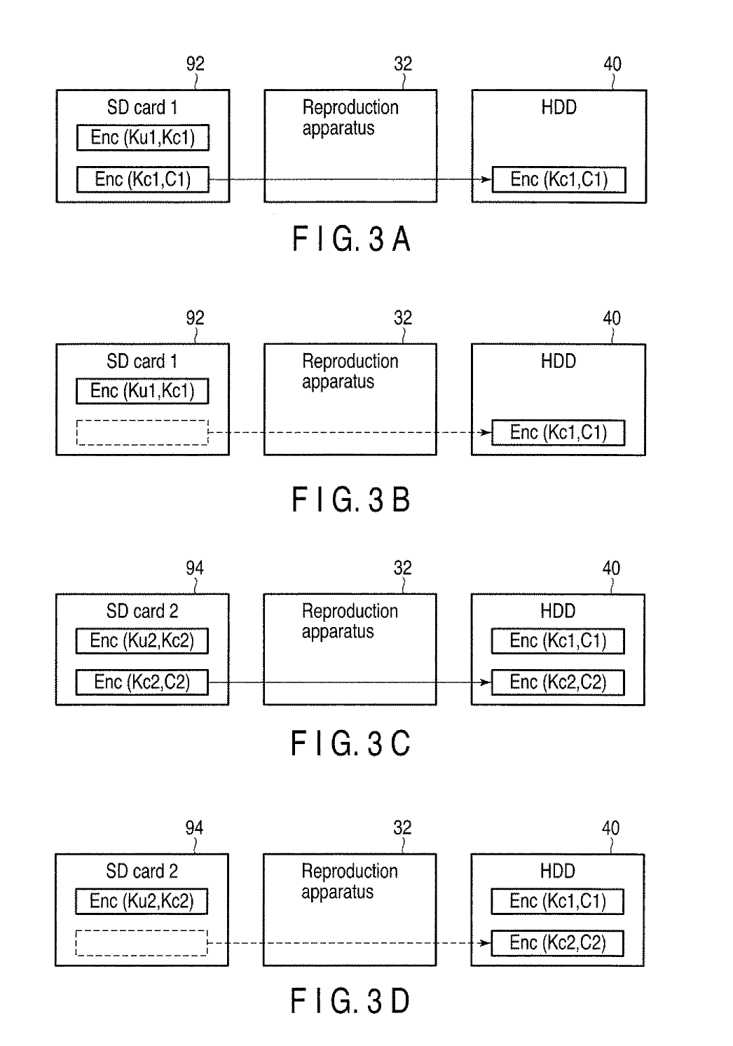

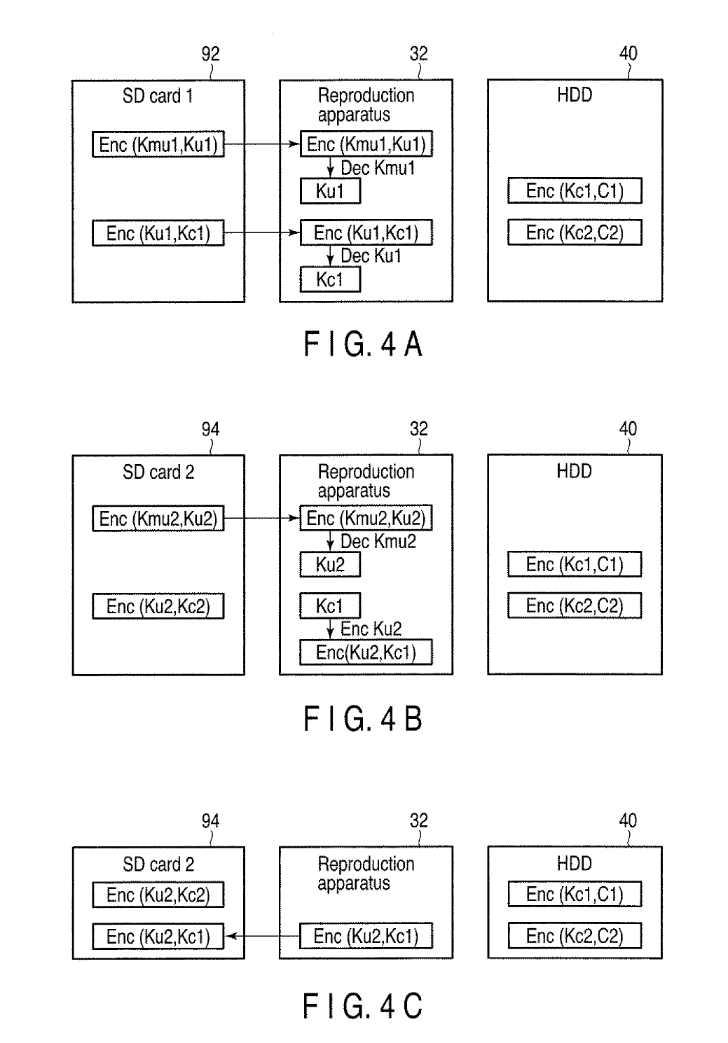

Movement of key according to the present invention will be described with reference to FIGS. 3A to 4C. It is explained in this example that encrypted content of an arbitrary SD card is moved to the HDD 40, and an encrypted content key is moved to a specific SD card. The specific SD card is referred to as a second SD card.

FIGS. 3A to 3D respectively indicate movement of encrypted content to the HDD 40. First of all, the SD card 92 is inserted into the card slot 52 of the reproduction apparatus 32. The reproduction apparatus 32 displays a menu screen for allowing a user-selected content to be moved. Assume a case in which content C1 is selected, an encrypted content Enc (Kc1, C1) is moved from the SD card 92 to the HDD 40 as shown in FIGS. 3A and 3B.

Similarly, when another SD card 94 is inserted into the card slot 52 of the reproduction apparatus 32, the reproduction apparatus 32 displays the menu screen for allowing the user-selected content to be moved. Assume a case in which content C2 is selected, an encrypted content Enc (Kc2, C2) is moved from the SD card 94 to the HDD 40 as shown in FIGS. 3C and 3D.

By repeating operation shown in FIGS. 3A to 3D with respect to a plurality of SD cards, an encrypted content Enc (Ken, Cn) stored in a plurality of SD cards are to be intensively stored in the HDD 40. Also, there will be a plurality of SD cards storing only keys since the contents are moved to the HDD 40.

When the keys dispersedly stored in a plurality of SD cards are to be brought together in one SD card, the reproduction apparatus 32 activates special software for key management. The display 64 displays a user interface for prompting the user to insert an SD card being a movement source into the card slot 52.

When the first SD card 92 is inserted into the card slot 52 of the reproduction apparatus 32, the reproduction apparatus 32 reads various information (MKB, media identifier IDm, media unique key Kmu1, encrypted user key Enc (Kmu1, Ku1), encrypted content key Enc (Ku1, Kc1)) from the first SD card 92, as shown in FIG. 4A. The reproduction apparatus 32 then obtains the media unique key Kmu1 through the MKB process (S2), hash process (S4), authentication and key exchange (Authentication Key Exchange [AKE]) process (S6), and further obtains a user key Ku1 by subjecting the encrypted user key Enc (Kmu1, Ku1) to the decryption process (S10). Furthermore, the reproduction apparatus 32 decrypts the encrypted content key Enc (Ku1, Kc1) with the user key Ku1 for obtaining a content key Kc1. The content key Kc1 is stored in the built-in memory 56.

Afterward, the display 64 displays an user interface for prompting the user to insert the second SD 94 card into the card slot 52. When the first SD card 92 is unplugged from the card slot 52 and the second SD card 94 is inserted into the card slot 52 of the reproduction apparatus 32, the reproduction apparatus 32 reads various information (MKB, media identifier IDm, media unique key Kmu2, encrypted user key Enc (Kmu2, Ku2), encrypted content key Enc (Ku1, Kc1)) from the second SD card 94, as shown in FIG. 4B. The reproduction apparatus 32 then obtains a media unique key Kmu2 through the MKB process (S2), hash process (S4), authentication and key exchange (Authentication Key Exchange [AKE]) process (S6), and further obtains a user key Ku2 by subjecting the encrypted user key Enc (Kmu2, Ku2) to the decryption process (S10). Furthermore, the reproduction apparatus 32 encrypts the content key Kc1 stored in the built-in memory 56 with the user key Ku2 for obtaining an encrypted content key Enc (Ku2, Kc1) for the second SD card 94, and stores the encrypted content key Enc (Ku2, Kc1) in the built-in memory 56.

Subsequently, as shown in FIG. 4C, the reproduction apparatus 32 writes the encrypted content key Eric (Ku2, Kc1) stored in the built-in memory 56 to the user data area of the second SD card 94. With the above process, two encrypted content keys Enc (Ku2, Kc1) and Enc (Ku2, Kc2), which correspond to two encrypted contents Enc (Kc1, C1) and Enc (Kc2, C2) stored in the HDD 40 is now stored in the user data area of the second SD card 94.

If free space of the second SD card 94 is small and it is not possible to write the encrypted content key Enc (Ku2, Kc1) for the second SD card 94 thereto, the display 64 displays a user interface for prompting the user to insert another SD card into the card slot 52.

By repeating operations shown in FIGS. 4A to 4C with respect to a plurality of SD cards, the encrypted content keys Enc (Kun, Kcn) stored in a plurality of SD cards are to be intensively stored in the second SD card 94. The second SD card 94 thereby becomes an exclusive storage medium for keys. All of the encrypted content keys stored in the second SD card 94 are encrypted with the user key Ku2 of the second SD card 94, and the user key Ku2 serves as an encryption key for the second SD card 94. The user key Ku2 is encrypted with the media unique key Kmu in the hidden area 16 and stored in the protected area 18.

During reproduction of contents, the display 64 displays an user interface for prompting the user to select content in the HDD 40. When a content is selected (here, a case in which the encrypted content Enc (Kc1, C1) is selected is assumed), the display 64 displays an user interface for prompting the user to insert an SD card storing the key into the card slot 52.

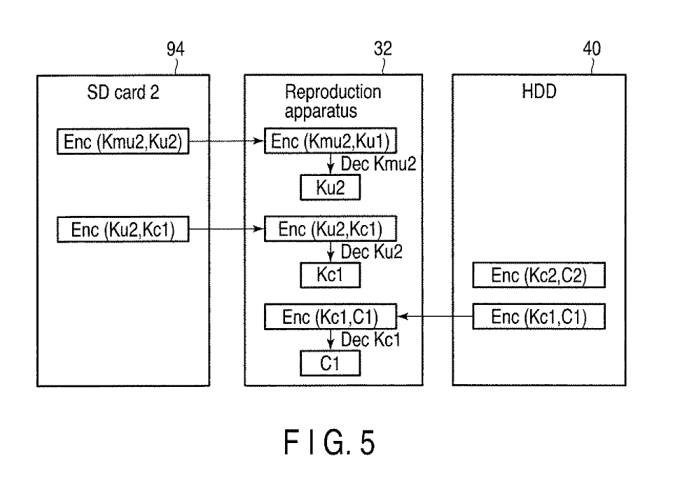

When the second SD card 94 is inserted into the card slot 52, the reproduction apparatus 32 reads various information (MKB, media identifier IDm, media unique key Kmu2, encrypted user key Enc (Kmu2, Ku2), encrypted content key Enc (Ku2, Kc1) for the selected content) from the SD card 94, as shown in FIG. 5. The reproduction apparatus 32 then obtains a media unique key Kmu2 through the MKB process (S2), hash process (S4), authentication and key exchange (Authentication Key Exchange [AKE]) process (S6), and further obtains a user key Ku2 by subjecting the encrypted user key Enc (Kmu2, Ku2) to the decryption process (S10). Furthermore, the reproduction apparatus 32 decrypts the encrypted content key Enc (Ku2, Kc1) with the user key Ku2 for obtaining a content key Kc1.

The reproduction apparatus 32 reads a specified encrypted content Enc (Kc1, C1) from the HDD 40, and decrypts the encrypted content Enc (Kc1, C1) by using the content key Kc1, thereby obtaining and reproducing content C1.

As explained above, according to the first embodiment, the encrypted content key is decrypted by using the user key of the SD card being the movement source for obtaining a content key, then the decrypted content key is encrypted with a user key of the specific SD card being the movement destination, and thereby encrypted content key is written to the user data area of the specific SD card being the movement destination. With this process, even in a case in which encrypted contents stored in a plurality of SD cards, which also store encrypted content keys, are intensively moved to a large-capacity storage device, the encrypted content keys are able to be intensively moved to a specific SD card. Therefore, when the encrypted contents stored in the large-capacity storage device are to be reproduced, there is no need for looking for SD cards respectively storing encrypted content keys for the respective encrypted contents to be reproduced. In other words, the encrypted contents can be surely reproduced. Furthermore, even if a third party steals an encrypted content key, the encrypted content key cannot be decrypted and a content corresponding to the encrypted content key cannot be decrypted accordingly, and the content can be thereby protected.

Other embodiments of the key management apparatus according to the present invention will now be explained. In the other embodiments, parts similar to those in the first embodiment are designated by the same reference numerals and detailed explanations are omitted.

In the first embodiment, when an abnormal process such as powering off while a content key is moved from the first SD card to the second SD card, there is a possibility that, depending on kinds of anomaly, the content key is lost, losing one opportunity out of an allowed number of times to move or copy, and furthermore, an effective content key is stored in both of the movement source and movement destination.

### Second Embodiment

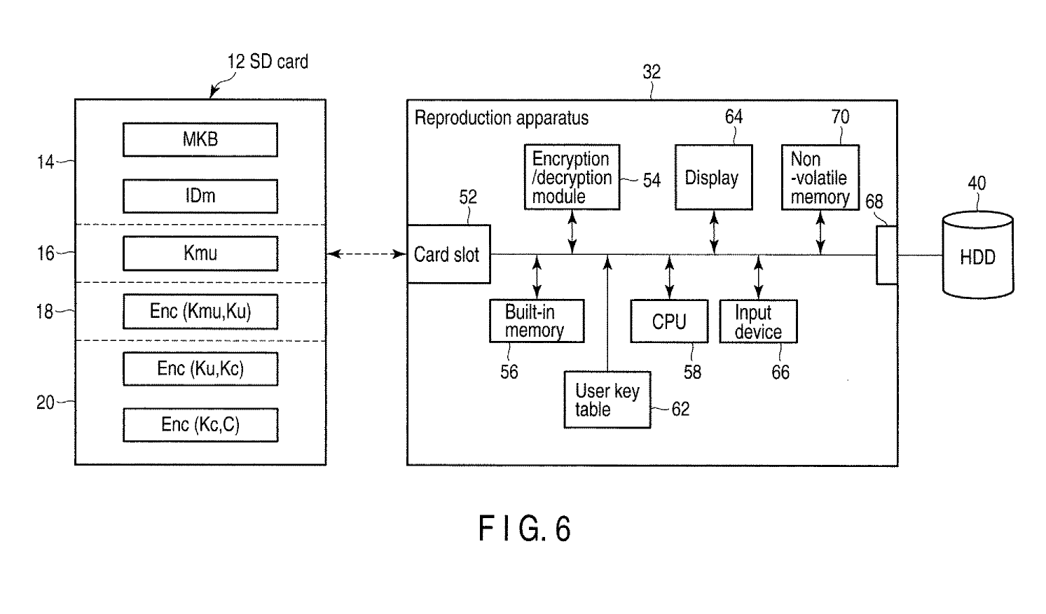

According to a second embodiment, a non-volatile storage is provided to the reproduction apparatus 32 for avoiding the above-mentioned problem. FIG. 6 shows a block diagram relating to the second embodiment. The first and second embodiments are similar, and the second embodiment differs from the first embodiment only in a point where the reproduction apparatus (key management apparatus) 32 includes a non-volatile memory 70. The built-in memory 56 cannot hold stored data any more when reproduction apparatus 32 is powered off. In contrast, the non-volatile memory 70 is able to hold stored data even after the reproduction apparatus 32 is powered off.

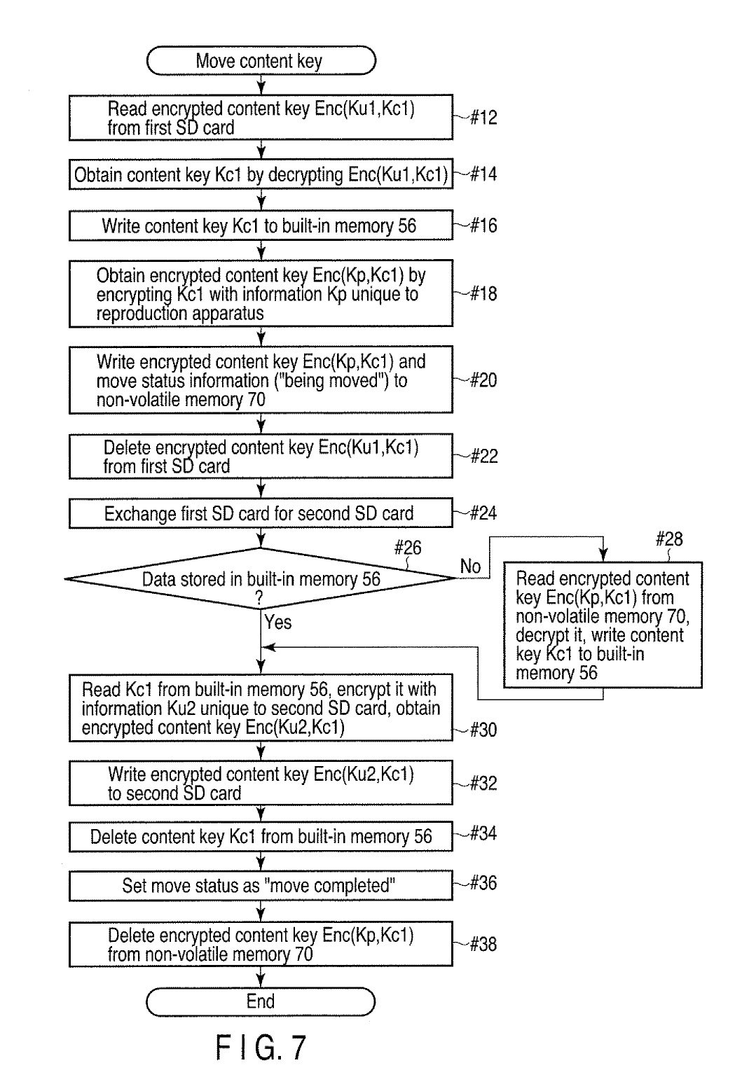

FIG. 7 is a flowchart of the CPU 58 of the reproduction apparatus 32 showing a key movement process according to the second embodiment. When a command for moving a key is selected on a menu screen, the flowchart of FIG. 7 is started.

When the first SD card is inserted into the card slot 52 in block #12, an encrypted content key Enc (Ku1, Kc1) is read from the first SD card. The encrypted content key Enc (Ku1, Kc1) is decrypted in block #14 and content key Kc1 is obtained. Details of decrypting a content key are similar to those of the process of the first embodiment explained with reference to FIG. 1. The content key Kc1 is written to the built-in memory 56 in block #16.

The content key Kc1 is encrypted with unique information Kp on the reproduction apparatus 32 (e.g., a serial number of the apparatus) in block #18, and an encrypted content key Enc (Kp, Kc1) is thereby obtained. The encrypted content key Enc (Kp, Kc1) is written to the non-volatile memory 70 in block #20, and at the same time, “being moved” is written to move status information, which indicates whether or not a key preliminarily stored in the non-volatile memory 70 is being moved.

The encrypted content key Enc (Ku1, Kc1) is deleted from the first SD card in block 422.

In block #24, the first SD card is unplugged from the card slot 52 and the second SD card is inserted into the card slot 52.

In block #26, whether or not data is stored in the built-in memory 56 is determined. This determination indicates whether or not the reproduction apparatus 32 has ever been powered off during a period of time between start of content movement (to be precise, after process of block 416) and the determination. If the data is stored, that data is determined to be the content key Kc1. In this case, block #30 is executed.

If no data is stored, it can be determined that the reproduction apparatus 32 is once powered off. In this case, the encrypted content key Enc (Kp, Kc1) is read from the non-volatile memory 70 of the reproduction apparatus 32 and decrypted by using Kp, and the content key Kc1 is thereby obtained in block #28. This content key Kc1 is to be stored in the built-in memory 56.

After block #28, or in a case where a determination result is YES in block #26, the content key Kc1 is read from the built-in memory 56 and encrypted with unique information on the second SD card (e.g., encrypted user key Ku2), and the encrypted content key Enc (Ku2, Kc1) is thereby obtained in block #30. Details of this encryption are similar to those of the process of the first embodiment explained with reference to FIG. 1.

The encrypted content key Enc (Ku2, Kc1) is written to the second SD card in block #32. The content key Kc1 is deleted from the built-in memory 56 in block #34. “Move completed” is written to move status information that is preliminarily stored in the non-volatile memory 70, in block #36. The encrypted content key Enc (Kp, Kc1) is deleted from the non-volatile memory 70 in block #38.

According to the process of FIG. 7, the content key Kc1, which is a result of decrypting the encrypted content key Enc (Ku1, Kc1) read from the first SD card, is written to the built-in memory 56, and the encrypted content key Enc (Kp, Kc1), which is a result of encrypting the content key Kc1 with unique information Kp on the reproduction apparatus 32 (e.g., a serial number of the apparatus), is written to the non-volatile memory 70. Therefore, even if the reproduction apparatus 32 is powered off while the key is being moved, the content key being moved is held in the non-volatile memory 70 in a condition being encrypted with the unique information on the reproduction apparatus 32, thereby preventing failures such as losing the content key, losing one opportunity out of the allowed number of times to move or copy, or furthermore, effective content key is stored in both of the movement source and the movement destination.

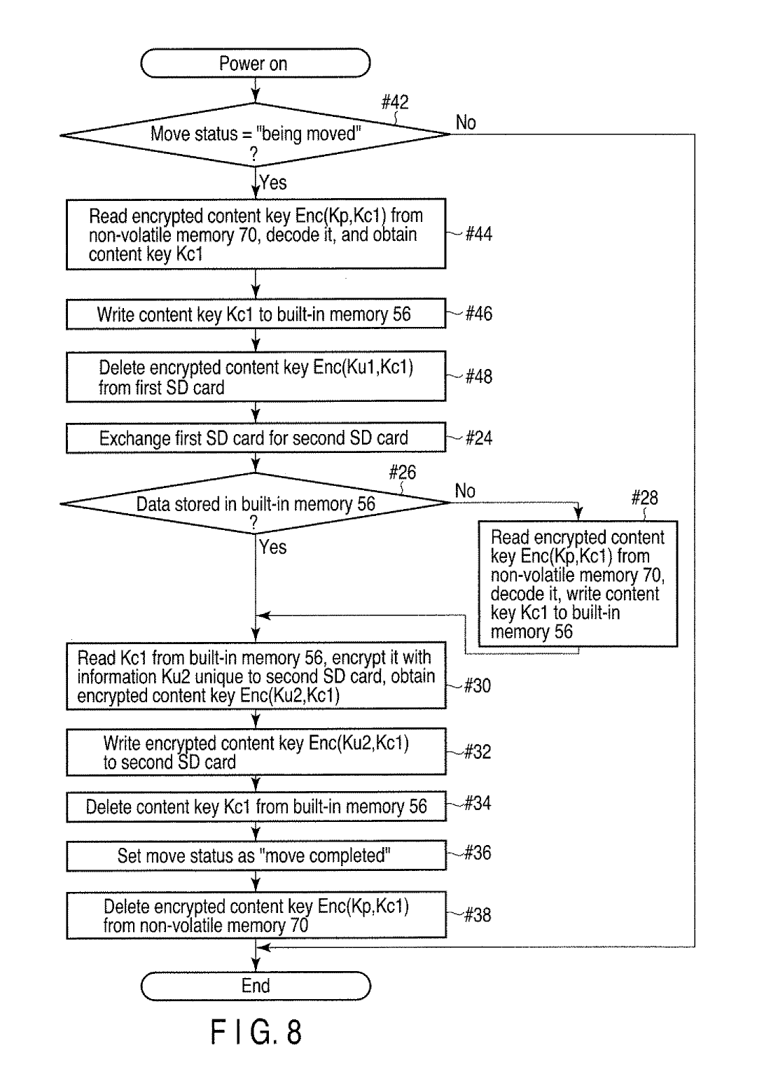

FIG. 8 is a flowchart relating to modification of the second embodiment. When the reproduction apparatus 32 is involuntarily powered off during a key movement process shown in FIG. 7 and powered on again, it is determined by the flowchart of FIG. 8 whether or not a failure occurred while the power is off. In order to determine whether a failure occurred during the power off, a process of FIG. 8 is executed at the time of powering on for securely executing normal movement.

When the apparatus is powered on, it is determined in block #42 whether or not the move status information in the non-volatile memory 70 indicates “being moved”. If it is determined not being moved, it can be determined that the key movement is completed normally, and the operation of FIG. 8 is therefore completed.

If the move status information indicates “being moved”, it can be determined that the apparatus might be once powered off during a period of time between block #22 to block #36 of FIG. 7. In this case, the encrypted content key Enc (Kp, Kc1) is read from the non-volatile memory 70 of the reproduction apparatus 32 in block #44 and decrypted by using Kp, for obtaining the content key Kc1. In block #46, the content key Kc1 is written to the built-in memory 56.

In block #48, the encrypted content key Enc (Ku1, Kc1) is deleted from the first SD card.

Subsequent process is similar to the process in FIG. 7. That is to say, the first SD card is exchanged to the second SD card in block #24.

In block #26, whether or not data is stored in the built-in memory 56 is determined. If data is stored, block #30 is executed. If no data is stored, in block #28, the encrypted content key Enc (Kp, Kc1) is read from the non-volatile memory 70 of the reproduction apparatus 32 and decrypted by using Kp, for obtaining the content key Kc1. This content key Kc1 is written to the built-in memory 56.

In block #30, the content key Kc1 is read from the built-in memory 56 and encrypted with unique information Ku2 of the second SD card, and the encrypted content key Enc (Ku2, Kc1) is thereby obtained.

In block #32, the encrypted content key Enc (ku2, Kc1) is written to the second SD card. The content key Kc1 is deleted from the built-in memory 56 in block #34. In block #36, “move completed” is written to the move status information preliminarily stored in the non-volatile memory 70. In block #38, the encrypted content key Enc (Kp, Kc1) is deleted from the non-volatile memory 70.

According to the process of FIG. 7, there is a possibility that the content key Kc1 in the built-in memory 56 is lost when the move status indicates “being moved” at the time of powering on. Therefore, according to the process of FIG. 8, the encrypted content key Enc (Kp, Kc1) is read from the non-volatile memory 70 and decrypted for obtaining the content key Kc1 in block #44. The content key Kc1 is then written to the built-in memory 56 in block #46. After the SD card is exchanged, the content key Kc1 is encrypted with the unique information Ku2 of the second SD card in block #30, and the thereby encrypted content key Enc (Ku2, Kc1) is written to the second SD card in block #32. Therefore, even if the apparatus is powered off while the key is being moved, failures such as losing the content key, losing one opportunity out of the allowed number of times to move or copy, and furthermore, effective content key is stored in both of the movement source and the movement destination, can be prevented.

As explained above, according to the second embodiment, it is possible to prevent failures such as losing the content key, losing one opportunity out of the allowed number of times to move or copy even if the apparatus is powered off while the key is being moved. It is because the content key can be reissued by using the encrypted content key stored in the non-volatile memory 70. Furthermore, after reading the key from the first SD card, the key is deleted therefrom, and after writing to the key to the second SD card, the key is deleted from the non-volatile memory. Thus, the effective key can be prevented from being written to both of the movement source and the movement destination.

### Third Embodiment

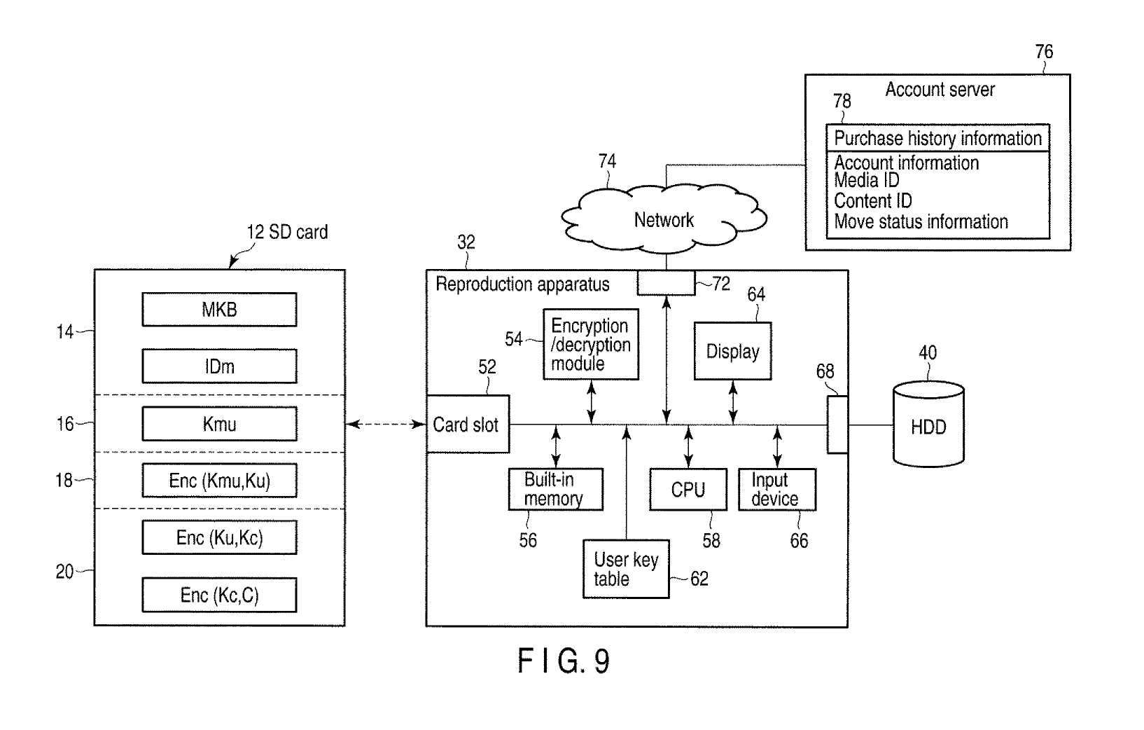

FIG. 9 is a diagram indicating an overall structure of a third embodiment. According to the above-described embodiments, the reproduction apparatus 32 executes key management. By contrast, according to the third embodiment, key management is executed by an account server 76 connected to the reproduction apparatus 32 via a network 74. The reproduction apparatus 32 of the present embodiment does not include a non-volatile memory 70. The reproduction apparatus 32 is connected to the network 74 via a network interface 72. The account server 76 manages purchase history information 78 which indicates purchase history of content. The purchase history information 78 comprises account information, media ID, content ID, and move status information. These pieces of information are set when a user moves content keys by using the reproduction apparatus 32.

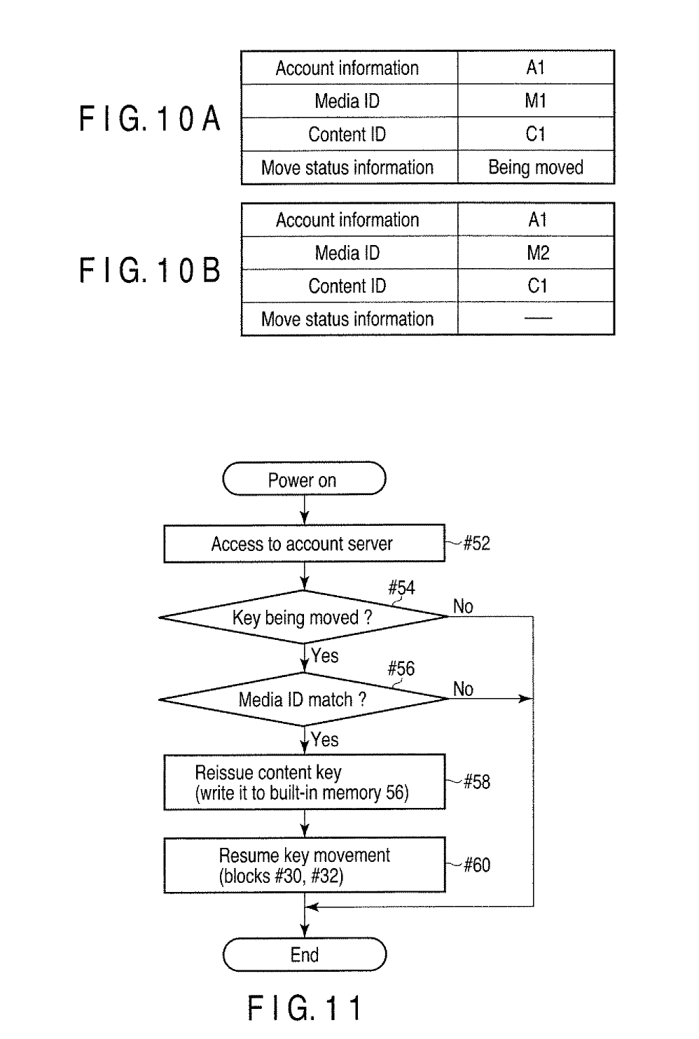

An example of the purchase history information 78 is shown in FIGS. 10A and 10B. When a user whose account ID is “A1” moves content (content ID: C1) and a corresponding content key from the first SD card (media ID: M1) to the second SD card (media ID: M2), for example, when a movement process shown in FIG. 7 is started, A1, M1 (media ID of a movement source), C1 are respectively set to the account ID, the media ID, and the content ID, and “being moved” flag is set in the move status information, as shown in FIG. 10A. For example, when movement process, from the first SD card to the second SD card, is finished, A1, M2 (media ID of the movement destination), and C1 are respectively set to the account ID, media ID, and content ID, and “being moved” flag on the move status information is deleted, as shown in FIG. 108.

In the key movement process according to the third embodiment, the account server 76 is accessed in block #52 for investigating move status information on the purchase history information 78.

In block #54, whether or not the move status information indicates “being moved” is determined. If determined that “being moved”, there is a possibility that the key is lost, and whether or not media ID of the first SD card being inserted in the card slot matches the media ID of the purchase history information 78 is determined in block #56. If the media IDs match, it is possible that after reading the content key from the first SD card being inserted in the card slot, the reproduction apparatus 32 may be powered off before the first SD card is exchanged to the second SD card and the key may be therefore lost. Thus, the content key is reissued in block #58. In other words, the account server 76 writes the content key Kc1 to the built-in memory 56.

Subsequently, key movement is resumed in block #60. More specifically, block #30 and block #32 of FIG. 7 are executed.

If a determination result is NO in block #54, it represents that the apparatus was powered off not during the key movement, and the process of FIG. 11 is terminated.

If the media IDs do not match in block #56, it means that the SD card being the movement source is already unplugged from the reproduction apparatus 32. Therefore, the key does not have to be reissued and the process is terminated.

As explained above, according to the third embodiment, when the apparatus is powered off during the key movement, the content key is reissued. Thus, it is possible to prevent failures such as losing the content key, and losing one opportunity out of the allowed number of times to move or copy.

Although only one card slot 52 is provided according to the above explanation, two card slots may be provided. If the apparatus is provided with two card slots, a specific SD card to which the keys are intensively moved can be always inserted. Therefore, it is possible to save the trouble of looking for an SD card exclusively provided for the keys and convenience improves. Furthermore, the SD card exclusive for the keys may be embedded in the reproduction apparatus, since the exclusive SD card does not have to be inserted to/unplugged from the reproduction apparatus unless a target reproduction apparatus changes. Although it is explained in the above explanation that the reproduction apparatus 32 comprises a special hardware, it may be realized by using a personal computer executing special software.

The above-described embodiments explained aggressive movement of keys, however, the keys may be deleted moved) in accordance with movement of content. For example, in a case where licensing of content stored in the first SD card allows only movement, the content of the first SD card is moved to an HDD, and an encrypted content key for a second SD card corresponding to the moved content is written to the second SD card, and subsequently, the encrypted content key corresponding to the content is deleted from the first SD card. With this process, content is securely moved. Also, in a case where licensing of content in the first SD card allows only limited number of times to copy, an encrypted content key for the second SD card corresponding to the content is written to the second SD card, and subsequently, a sum of an allowed number of times to copy (stored in the protected area) with respect to the content in the first SD card and an allowed number of times to copy (stored in the protected area) with respect to the content in the second SD card is set equal to an original limited allowed number of times to copy. With this process, copying exceeding the limited allowed number of times can be prevented.

As explained above, a plurality of keys for a plurality of contents, which are dispersedly purchased and stored in a plurality of information storage media, can be brought together in one information storage medium. Therefore, in a case where a plurality of contents are to be reproduced after being brought together in one storage, a user is free from the trouble of looking for information storage media respectively storing keys corresponding to contents to be reproduced.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

What is claimed is:

1. A key management apparatus configured to access an information storage medium comprising a user data area for storing encrypted content and encrypted content key, the encrypted content being encrypted with a content key in a plain version and the encrypted content key being encrypted on the basis of a media unique key unique to the medium and a hidden area for storing the media unique key, the apparatus comprising:
a decrypting module configured to read a media unique key and an encrypted content key which corresponds to a selected content from a first information storage medium and to decrypt the encrypted content key with the media unique key read from the first information storage medium in order to obtain a content key in a plain version;
an encryption module configured to read a media unique key from the second information storage medium and to encrypt the content key in the plain version with the media unique key read from the second information storage medium in order to obtain an encrypted content key for the second information storage medium; and
a write module configured to write the encrypted content key for the second information storage medium to a user data area of the second information storage medium.

2. The apparatus of claim 1, wherein the information storage medium further comprises a protected area for storing a user key being encrypted with the media unique key, and the content key is encrypted with a user key being encrypted with the media unique key.

3. The apparatus of claim 2, wherein the information storage medium further comprises a system area for storing a media identifier and a media key block, the apparatus further comprising:
a first module configured to subject the media key block read from the second storage medium to a media key block process with a device key in order to obtain a media key;
a second module configured to subject the media identifier read from the second storage medium and the media key obtained through the first module to a hash process in order to obtain a media unique key;
a third module configured to execute authentication of the information storage medium by cross-checking the media unique key read from the second information storage medium and the media unique key obtained through the second module;
a fourth module configured to read the encrypted user key from the second information storage medium when the authentication is successful and to decrypt the encrypted user key with the media unique key obtained through the second module in order to obtain a user key;
a fifth module configured to read the encrypted content key from the second information storage medium and to decrypt the encrypted content key with the user key obtained through the fourth module in order to obtain a content key in a plain version; and
a sixth module configured to decrypt an encrypted content with the content key obtained through the fifth module.

4. The apparatus of claim 1, wherein the information storage medium comprises a memory card, the apparatus further comprises a slot for the memory card.

5. The apparatus of claim 1, wherein the information storage medium comprises a memory card, the apparatus further comprises two slots for the memory card.

6. The apparatus of claim 1, wherein the information storage medium comprises a memory card, the apparatus further comprises a slot for the memory card, and wherein the second information storage medium is incorporated in the apparatus.

7. The apparatus of claim 1, further comprising:
a read module configured to read an encrypted content from the information storage medium; and
a memory configured to store the encrypted content read by the read module.

8. The key management apparatus of claim 1, further comprising:
a volatile memory configured to store the content key obtained by the decrypting module; and
a non-volatile memory configured to store an encrypted content key, which is obtained by encrypting the content key obtained by the decrypting module with unique information of the apparatus.

9. The apparatus of claim 8, further comprising:
a determination module configured to determine whether not data is stored in the volatile memory; and
a second write module configured to write a content key obtained by decrypting the encrypted content key stored in the non-volatile memory to the volatile memory, when the determination module determines that data is not stored in the volatile memory.

10. The key management apparatus of claim 8, wherein the non-volatile memory stores move status information on a key, the apparatus further comprising:
a determination module configured to determine whether or not the move status information indicates “being moved” at a time of power-on; and
a second write module configured to write a content key obtained by decrypting the encrypted content key stored in the non-volatile memory to the volatile memory, when the determination module determines that the move status information indicates “being moved”.

11. A key management method for a key management apparatus configured to access an information storage medium comprising a user data area for storing encrypted content and encrypted content key, the encrypted content being encrypted with a content key in a plain version and the encrypted content key being encrypted on the basis of a media unique key unique to a medium and a hidden area for storing the media unique key, the method comprising:
decrypting for obtaining a content key in a plain version, by reading a media unique key and an encrypted content key which corresponds to a selected content from a first information storage medium and decrypting the encrypted content key with the media unique key read from the first information storage medium;
encrypting for obtaining an encrypted content key for a second information storage medium, by reading a media unique key from the second information storage medium and encrypting the content key in the plain version with the media unique key; and
writing the encrypted content key for the second information storage medium to a user data area of the second information storage medium.

12. The key management method of claim 11, wherein the information storage medium further comprises a protected area for storing a user key being encrypted with the media unique key, and the content key is encrypted with the user key being encrypted with the media unique key.

13. The key management method of claim 12, wherein the information storage medium further comprises a system area for storing a media identifier and a media key block, the method further comprising:
a first step of subjecting the media key block read from the second storage medium to a media key block process by with a device key in order to obtain a media key;
a second step of subjecting the media identifier read from the second storage medium and the media key obtained through the first step to a hash process in order to obtain a media unique key;
a third step of executing authentication of the information storage medium by cross-checking the media unique key read from the second information storage medium and the media unique key obtained through the second step;
a fourth step of reading the encrypted user key from the second information storage medium when the authentication is successful and of decrypting the encrypted user key with the media unique key obtained through the second step in order to obtain a user key;
a fifth step of reading the encrypted content key from the second information storage medium and of decrypting the encrypted content key with the user key obtained through the fourth step in order to obtain a content key in a plain version; and
a sixth step of decrypting an encrypted content with the content key obtained through the fifth step.

14. The key management method of claim further comprising:
reading an encrypted content from the information storage medium; and
writing the encrypted content read through the reading to a memory.

15. The key management method of claim 11, further comprising writing an encrypted content key for the second information storage medium corresponding to a first content to the second information storage medium and deleting the encrypted content key corresponding to the first content from the first information storage medium when licensing of the first content of the first information storage medium allows only movement.

16. The key management method of claim 11, further comprising writing an encrypted content key for the second information storage medium corresponding to a first content of the first information storage medium to the second information storage medium and setting a sum of an allowed number of times to copy of the first content of the first information storage medium and an allowed number of times to copy of a first content of the second information storage medium equal to an initial limited allowed number of times to copy when licensing of a first content of the first information storage medium allows the limited number of times to copy.

17. The key management method of claim 11, further comprising:
writing the content key obtained through the decryption to a volatile memory; and
writing an encrypted content key, which is obtained by encrypting the content key obtained through the decryption with predetermined information, to a non-volatile memory.

18. The key management method of claim 17, further comprising:
determining whether or not data is stored in the volatile memory; and
writing a content key obtained by decrypting the encrypted content key stored in the non-volatile memory to the volatile memory, when it is determined that data is not stored in the volatile memory.

19. The key management method of claim 17, further comprising:
writing move status information on a key to the non-volatile memory;
determining whether or not the move status information indicates that a content is moving at a time of power-on; and
writing a content key obtained by decrypting the encrypted content key stored in the non-volatile memory to the volatile memory, when it is determined that the move status information indicates that a content is moving.

20. A key management system comprising:
a key management apparatus configured to access an information storage medium comprising a user data area for storing encrypted content and encrypted content key, the encrypted content being encrypted with a content key in a plain version and the encrypted content key being encrypted on the basis of a media unique key unique to the medium and a hidden area for storing the media unique key; and
a server connected to the key management apparatus;
wherein the key management apparatus comprises:
a decrypting module configured to read a media unique key and an encrypted content key which corresponds to a selected content from a first information storage medium and to decrypt the encrypted content key with the media unique key read from the first information storage medium in order to obtain a content key in a plain version;
an encryption module configured to read a media unique key from the second information storage medium and to encrypt the content key in the plain version with the media unique key read from the second information storage medium in order to obtain an encrypted content key for the second information storage medium; and
a write module configured to write the encrypted content key for the second information storage medium to a user data area of the second information storage medium, and
the server manages move status information on a key, and comprises:
a determination module configured to determine whether or not the move status information indicates that a content is moving; and
a reissue module configured to reissue a content key when the determining module determines that the move status information indicates that a content is moving.

21. The key management system of claim 20, wherein
the server manages identification information on an information storage medium to which the key management apparatus accesses,
the determining module determines, at a time of power-on, whether or not the identification information on the information storage medium to which the key management apparatus accesses and the identification information being managed by the server match, and
the reissue module reissues a content key when the determination module determines that the move status information indicates that a content moving and the identification information on the information storage medium and the identification information being managed by the server match.
